(19) United States
(12) Patent Application Publication
(10) Pub. No.: US 2012/0024195 A1
(43) Pub. Date: Feb. 2, 2012

(54) CALCIUM PHOSPHATE CEMENT COMPOSITION AND ITS KIT FOR BONE PROSTHESIS

(75) Inventor: Daisuke Shoji, Tokyo (JP)

(73) Assignee: HOYA CORPORATION, Tokyo (JP)

(21) Appl. No.: 13/264,511

(22) PCT Filed: Apr. 14, 2010
(86) PCT No.: PCT/JP2010/056684

§ 371 Date: Oct. 14, 2011

(30) Foreign Application Priority Data
Apr. 17, 2009 (JP) 2009-101140

(51) Int. Cl. C04B 12/02

(52) U.S. Cl. 106/691

(57) ABSTRACT

A calcium phosphate cement composition kit comprising (A) a powdery agent comprising (a) 100 parts by mass of calcium phosphate powder, and (b) 10-50 parts by mass of a powdery foaming agent comprising carbonate or hydrogen carbonate and a solid organic acid or its salt, and (B) an aqueous blending liquid containing a thickener in a concentration of 2.5-12.5% by mass, a paste-like mixture obtained by blending the powdery agent with the aqueous blending liquid being filled in a predetermined prosthetic site in a human body to form a porous calcium phosphate body having porosity of 60% or more.

### FIELD OF THE INVENTION

The present invention relates to a calcium phosphate cement composition suitable for a high-porosity, high-strength bone prosthesis material having proper communicating pores and fit into a prosthetic site having an arbitrary shape, and its kit.

### BACKGROUND OF THE INVENTION

With high affinity for autogenous bones, calcium phosphate is used as a prosthesis material for bones and teeth injected into a predetermined site in a human body in plastic surgery, neurological surgery, plastic and reconstructive surgery, oral surgery, etc. The methods of using calcium phosphate-based bone prosthesis materials include (1) a method of embedding a sintered body of calcium phosphate powder in a predetermined site in a human body, and (2) a method of injecting a paste-like mixture obtained by blending a calcium phosphate cement with an aqueous hardening liquid into a predetermined site in a human body, and hardening it. In the method (2), because the bone prosthesis material has a high degree of shape freedom, it can be easily fit into a prosthetic site having an arbitrary shape.

As bone prosthesis materials used in the method (2), various calcium phosphate cements have been proposed. For instance, Japanese Patent 3966539 discloses a quick-hardening, living-bone-reinforcing calcium phosphate cement comprising 5-500 ppm of bone morphogenetic proteins, 0.03-2% by mass of magnesium phosphate, and 5-35% by mass of dibasic calcium phosphate, the balance being tetrabasic calcium phosphate and inevitably contained hydroxyapatite, the bone morphogenetic proteins being carried on dibasic calcium phosphate surfaces. However, because a hardened body of this calcium phosphate cement has small pore sizes and porosity, with many independent pores not communicating with each other, cells and bone morphogenetic proteins do not fully enter the pores, resulting in slow bone regeneration. To have excellent bone induction, hardened calcium phosphate should have pores in which cells and bone morphogenetic proteins enter and are fixed. Accordingly, the hardened calcium phosphate is required to have communicating pores with proper diameters.

WO 02/36518 A1 discloses a self-hardening bone cement kit comprising a liquid agent containing a first reaction component (sodium phosphate), acid such as citric acid, and a powdery agent containing second reaction components (a calcium source and a phosphoric acid source) reacted with the first reaction component to form a self-hardening bone cement, the powdery agent comprising carbonate selected from the group consisting of sodium carbonate, sodium hydrogen carbonate, calcium carbonate, calcium hydrogen carbonate and mixtures thereof, a weight ratio of the acid and carbonate to the first and second reaction components being about 10-20%. However, because this kit does not contain a thickener, a carbon dioxide gas generated by the reaction of carbonate and acid is not sufficiently retained in the cement, resulting in as small porosity as about 50% or less.

### OBJECT OF THE INVENTION

Accordingly, an object of the present invention is to provide a calcium phosphate cement composition fit into a prosthetic site of an arbitrary shape and suitable for a high-porosity, high-strength bone prosthesis material having proper communicating pores, and its kit.

### DISCLOSURE OF THE INVENTION

As a result of intensive research in view of the above object, the inventor has found that the blending of (a) calcium phosphate powder and (b) a powdery foaming agent comprising carbonate or hydrogen carbonate and a solid organic acid or its salt with an aqueous blending liquid containing a thickener provides a paste-like mixture, which has proper communicating pores, and is fit into a prosthetic site having an arbitrary shape to form a high-porosity, high-strength, porous body. The present invention has been completed based on such finding.

Thus, the calcium phosphate cement composition of the present invention comprises (a) 100 parts by mass of calcium phosphate powder, (b) 10-50 parts by mass of a powdery foaming agent comprising carbonate or hydrogen carbonate and a solid organic acid or its salt, and (c) 15-50 parts by mass of an aqueous blending liquid, the aqueous blending liquid containing a thickener in a concentration of 2.5-12.5% by mass, a paste-like mixture obtained by their blending being filled in a predetermined prosthetic site in a human body to form a porous calcium phosphate body having porosity of 60% or more.

The calcium phosphate cement composition kit of the present invention comprises (A) a powdery agent comprising (a) 100 parts by mass of calcium phosphate powder, and (b) 10-50 parts by mass of a powdery foaming agent comprising carbonate or hydrogen carbonate and a solid organic acid or its salt, and (B) an aqueous blending liquid containing a thickener in a concentration of 2.5-12.5% by mass, a paste-like mixture obtained by blending the powdery agent with the aqueous blending liquid in such a proportion that the aqueous blending liquid is 15-50 parts by mass per 100 parts by mass of the calcium phosphate powder being filled in a predetermined prosthetic site in a human body to form a porous calcium phosphate body having porosity of 60% or more.

In order that the paste-like mixture has a proper hardening time, and that the porous calcium phosphate body has excellent bone absorption/substitution capability (capability of being absorbed and substituted with autogenous bones), the calcium phosphate powder preferably comprises tribasic calcium phosphate powder as a main component. The more preferred composition of the calcium phosphate powder comprises, in addition to the tribasic calcium phosphate powder, 2-10% by mass of dibasic calcium phosphate powder, 10-25% by mass of tetrabasic calcium phosphate powder, 5% or less by mass of other calcium phosphate compound powders than the dibasic to tetrabasic calcium phosphates, and further 0.03-2% by mass of magnesium phosphate powder for improving the fluidity of the paste-like mixture. The most preferable composition of the calcium phosphate powder comprises, in addition to tribasic calcium phosphate powder, 3-7% by mass of dibasic calcium phosphate powder, 15-20% by mass of tetrabasic calcium phosphate powder, and 3% or less by mass of other calcium phosphate compound powders than the dibasic to tetrabasic calcium phosphates, and further 0.05-0.5% by mass of magnesium phosphate powder.

The carbonate is preferably at least one selected from the group consisting of sodium carbonate, potassium carbonate, magnesium carbonate, calcium carbonate and ammonium carbonate. The hydrogen carbonate is preferably at least one selected from the group consisting of sodium hydrogen carbonate, potassium hydrogen carbonate, magnesium hydrogen carbonate, calcium hydrogen carbonate and ammonium hydrogen carbonate. Among them, sodium hydrogen carbonate is most preferable.

The solid organic acid is preferably at least one selected from the group consisting of solid aliphatic carboxylic acids, solid aliphatic hydroxycarboxylic acids, ascorbic acid, aspartic acid and glutamic acid. Among them, citric acid is most preferable.

The thickener is preferably at least one selected from the group consisting of sodium chondroitin sulfate, sodium hyaluronate and carboxymethylcellulose.

The calcium phosphate cement composition preferably further comprises 2-10 parts by mass of a hardening accelerator per 100 parts by mass of the calcium phosphate powder. In the case of the calcium phosphate cement composition kit, the hardening accelerator is preferably added to the aqueous blending liquid. The hardening accelerator is preferably at least one selected from the group consisting of sodium lactate, disodium succinate, sodium phosphate and sodium chloride.

### BRIEF DESCRIPTION OF THE DRAWINGS

FIG. 1 is a scanning electron photomicrograph (magnification: 50 times) showing the porous calcium phosphate body of Example 1.

FIG. 2 is a scanning electron photomicrograph (magnification: 50 times) showing the porous calcium phosphate body of Example 2.

FIG. 3 is a scanning electron photomicrograph (magnification: 50 times) showing the porous calcium phosphate body of Comparative Example 1.

### DESCRIPTION OF THE PREFERRED EMBODIMENTS

### [1] Calcium Phosphate Cement Composition

(1) Calcium Phosphate Powder

The calcium phosphate powder, which is hardened by a hydration reaction to form a porous body, preferably comprises tribasic calcium phosphate (tricalcium phosphate) powder as a main component. The more preferred composition of the calcium phosphate powder comprises 2-10% by mass of dibasic calcium phosphate (calcium hydrogen phosphate) powder, 10-25% by mass of tetrabasic calcium phosphate (tetracalcium phosphate) powder, and 5% or less by mass of other calcium phosphate compound powders than the dibasic to tetrabasic calcium phosphates, per 100% by mass of the entire calcium phosphate powder, the balance being tribasic calcium phosphate powder. The calcium phosphate powder preferably further comprises 0.03-2% by mass of magnesium phosphate powder. Each component powder may be anhydride or hydrate, and when the hydrate powder is used, its amount is expressed by an amount as anhydride.

(a) Tribasic Calcium Phosphate

Tribasic calcium phosphate, a main component, is preferably of an a type, but it may be a mixture of an α type and a β in a range not hindering the effects of the present invention. The particle size range of the tribasic calcium phosphate powder is preferably about 0.1-500 μm, more preferably about 1-100 μdm. The average particle size of the tribasic calcium phosphate powder is preferably about 1-50 μm, more preferably about 2-10 μm. The amount of the tribasic calcium phosphate powder is preferably 60% or more by mass, more preferably 65% or more by mass, most preferable 70% or more by mass, per 100% by mass of the entire calcium phosphate powder.

(b) Dibasic Calcium Phosphate

The dibasic calcium phosphate has a function of accelerating hardening. The particle size range and average particle size of the dibasic calcium phosphate powder may be the same as those of the tribasic calcium phosphate powder. To obtain a proper hardening time, the amount of the dibasic calcium phosphate powder is preferably 2-10% by mass, more preferably 3-7% by mass, per 100% by mass of the entire calcium phosphate powder.

(c) Tetrabasic Calcium Phosphate

The tetrabasic calcium phosphate has a function of accelerating the absorption and substitution of the porous calcium phosphate body to an autogenous bone. The particle size range and average particle size of tetrabasic calcium phosphate may be the same as those of the tribasic calcium phosphate powder. In order that the porous calcium phosphate body has sufficient bone absorption/substitution capability and strength, the amount of the tetrabasic calcium phosphate powder is preferably 10-25% by mass, more preferably 15-20% by mass, per 100% by mass of the entire calcium phosphate powder.

(d) Other Calcium Phosphate Compounds than Dibasic to Tetrabasic Calcium Phosphates

Other calcium phosphate compound powders than the dibasic to tetrabasic calcium phosphates, which are inevitably contained, include, for example, hydroxyapatite powder. The particle size range and average particle size of this calcium phosphate compound powder may be the same as those of the tribasic calcium phosphate powder. The amount of this calcium phosphate compound powder is preferably 5% or less by mass, more preferably 3% or less by mass, per 100% by mass of the entire calcium phosphate powder.

(e) Magnesium Phosphate

The magnesium phosphate is preferably tribasic magnesium phosphate (trimagnesium phosphate), but it may contain, in addition to tribasic magnesium phosphate, other magnesium phosphates such as monobasic magnesium phosphate (magnesium dihydrogen phosphate), dibasic magnesium phosphate (magnesium hydrogen phosphate), magnesium pyrophosphate, etc., in a range not hindering the effects of the present invention. The particle size range and average particle size of the magnesium phosphate powder may be the same as those of the tribasic calcium phosphate powder. In order that a paste-like mixture of the calcium phosphate powder has good fluidity, the amount of the magnesium phosphate powder is preferably 0.03-2% by mass, more preferably 0.05-0.5% by mass, per 100% by mass of the entire calcium phosphate powder.

(2) Powdery Foaming Agent

The powdery foaming agent comprises carbonate or hydrogen carbonate and a solid organic acid or its salt. The carbonate or hydrogen carbonate generates a carbon dioxide gas by a neutralization reaction with the solid organic acid or its salt. The carbonates or hydrogen carbonates preferably include carbonates or hydrogen carbonates of alkali metals or alkaline earth metals, for example, sodium carbonate, potassium carbonate, magnesium carbonate, calcium carbonate, sodium hydrogen carbonate, potassium hydrogen carbonate, magnesium hydrogen carbonate, calcium hydrogen carbonate, etc. Ammonium carbonate and ammonium hydrogen carbonate may also be used. Among them, sodium hydrogen carbonate is most preferable.

The solid organic acids include solid aliphatic carboxylic acids, solid aliphatic hydroxycarboxylic acids, ascorbic acid, aspartic acid, glutamic acid, etc. The solid organic acid salts include their sodium salts, potassium salts, etc.

The solid aliphatic carboxylic acids may be either saturated or unsaturated; the solid saturated aliphatic carboxylic acids include capric acid, palmitic acid, margaric acid, malonic acid, succinic acid, glutaric acid, adipic acid, pimelic acid, suberic acid, azelaic acid, sebacic acid, etc., and the solid unsaturated aliphatic carboxylic acids include fumaric acid, maleic acid, aconitic acid, oleic acid, linoleic acid, linolenic acid, etc. The solid aliphatic hydroxycarboxylic acids may be either saturated or unsaturated, including glycolic acid, lactic acid, hydroxybutyric acid, malic acid, tartaric acid, carboxymethyltartaric acid, hydroxycaproic acid, citric acid, gluconic acid, galacturonic acid, glucuronic acid, mannuronic acid, etc. Among them, citric acid is most preferable.

For example, in the case of a combination of sodium hydrogen carbonate and citric acid, a carbon dioxide gas is generated by the following reaction.

3NaHCO₃+CH₂(COOH)—C(OH)(COOH)—CH₂(COOH)→CH₂(COONa)-C(OH)(COONa)-CH₂(COONa)+3H₂O+3CO₂

Sodium hydrogen carbonate is a monovalent base, while citric acid is a trivalent acid. Accordingly, when they are mixed at a molar ratio of 3:1, a neutralization reaction occurs stoichiometrically. Namely, the chemical equivalent ratio of sodium hydrogen carbonate to citric acid is preferably substantially 1, though there would be no problems even if sodium hydrogen carbonate were slightly excessive. This molar ratio is applicable to general carbonates and solid organic acids.

To obtain a porous calcium phosphate body having proper communicating pores, the amount of the powdery foaming agent is 10-50 parts by mass, preferably 15-40 parts by mass, more preferably 20-40 parts by mass, per 100 parts by mass of the calcium phosphate powder.

(3) Aqueous Blending Liquid

The powdery foaming agent and water cause a neutralization reaction to generate a carbon dioxide gas, so that the calcium phosphate powder is turned to a foamed, paste-like mixture. To make the paste-like mixture highly viscous to retain pores in the paste, the amount of the aqueous blending liquid is 15-50 parts by mass, preferably 20-40 parts by mass, more preferably 25-38 parts by mass, per 100 parts by mass of the calcium phosphate powder.

(4) Components of Aqueous Blending Liquid

(a) Thickeners

The thickeners include mucopolysaccharides such as sodium chondroitin sulfate and sodium hyaluronate, and high-molecular-weight compounds such as carboxymethylcellulose, etc. They may be added alone or in combination. The concentration of the thickener is determined, such that a carbon dioxide gas generated by the neutralization reaction of carbonate and acid sufficiently remains in the paste, and that the paste has such viscosity that it is not broken by foaming. Taking into consideration the easiness of forming the paste-like mixture, the concentration of the thickener is 2.5-12.5% by mass, preferably 6-12% by mass, more preferably 7-11% by mass. A higher thickener concentration in the aqueous blending liquid provides the paste-like mixture with higher viscosity, resulting in pores well retained in the paste-like mixture while preventing the breakage of the paste by foaming.

(b) Hardening Accelerator

The aqueous blending liquid preferably comprises a hardening accelerator for the calcium phosphate powder. The hardening accelerator may be a water-soluble sodium salt such as sodium lactate, disodium succinate, sodium phosphate, sodium chloride, etc. They may be used alone or in combination. The amount of the hardening accelerator is preferably 2-10 parts by mass, more preferably 3-7 parts by mass, most preferable 4-6 parts by mass, per 100 parts by mass of the calcium phosphate powder.

### [2] Calcium Phosphate Cement Composition Kit

The calcium phosphate cement composition kit comprises (A) a powdery agent comprising (a) 100 parts by mass of calcium phosphate powder, and (b) 10-50 parts by mass of a powdery foaming agent comprising carbonate or hydrogen carbonate and a solid organic acid or its salt, and (B) an aqueous blending liquid containing a thickener in a concentration of 2.5-12.5% by mass. The aqueous blending liquid preferably further contains a hardening accelerator for the calcium phosphate powder.

Because the powdery agent comprises the powdery foaming agent comprising carbonate or hydrogen carbonate and a solid organic acid or its salt, the ratio of carbonate or hydrogen carbonate to a solid organic acid or its salt does not change depending on the ratio of the powdery agent to the aqueous blending liquid. Accordingly, at any viscosity of the paste-like mixture, a neutralization reaction occurs completely between carbonate or hydrogen carbonate and a solid organic acid or its salt.

When the powdery agent comprising the calcium phosphate powder and the powdery foaming agent is blended with the aqueous blending liquid containing the thickener to cause the hydration and hardening reaction of the calcium phosphate powder and the neutralization reaction of the powdery foaming agent simultaneously, a paste-like mixture having relatively high viscosity is obtained by the thickener in the aqueous blending liquid, resulting in a porous body having sufficient strength despite high porosity. The ratio of the powdery agent to the aqueous blending liquid is determined such that the resultant paste-like mixture has desired viscosity and fluidity.

The powdery agent and the aqueous blending liquid at a desired ratio are blended, for instance, by a spatula in a mortar. The resultant paste-like mixture is injected into a predetermined bone prosthetic site in a human body, using a syringe. Because the paste-like mixture is hardened in about 10 minutes, blending and injection should be completed within several minutes. When the paste-like mixture has high viscosity, a high-pressure syringe pump is used.

### [3] Properties of Porous Calcium Phosphate Body

A porous calcium phosphate body obtained from the calcium phosphate cement composition of the present invention has a skeleton constituted by hydroxyapatite [Ca₁₀(PO₄)₆.(OH)₂] crystals formed by the hydration reaction of the calcium phosphate powder, and communicating pores formed by the foaming of the powdery foaming agent.

The porous calcium phosphate body has communicating pores having as wide a pore diameter range (pore diameter distribution) as about 1000 μm or less, with many communicating pores having a pore diameter range of about 5-1000 μm, particularly about 10-800 μm, in which cells (hematopoietic cells, stem cells, etc.) and bone morphogenetic proteins (bone-forming proteins, fibroblast growth factors, etc.) can easily enter and be fixed. The average pore diameter of communicating pores is about 50-500 μm, particularly about 100-400 μm. The pore diameter distribution and average pore diameter of communicating pores can be determined by the image analysis of a scanning electron photomicrograph.

The porosity of the porous calcium phosphate body is 60% or more, preferably 65-95%, particularly 70-90%. In the present invention, because the paste-like mixture containing the thickener has high viscosity, the porous calcium phosphate body has sufficient self-supportability even at high porosity of up to 95%. With the porosity of less than 60%, sufficient cells and bone morphogenetic proteins do not enter the porous calcium phosphate body, failing to achieve large osteogenic capacity. Because larger porosity provides smaller mechanical strength to the porous calcium phosphate body, the percentage of the aqueous blending liquid is determined to obtain optimum porosity.

In the porous calcium phosphate body having communicating pores having the above pore diameter distribution and average pore diameter, as well as the above porosity, cells and bone morphogenetic proteins easily enter and are fixed, resulting in rapid bone regeneration.

Because hydroxyapatite is formed by the hydration reaction of calcium phosphate, the porous calcium phosphate body comprises hydroxyapatite as a main component. Because hydroxyapatite is a main component of the bone, the porous calcium phosphate body has high affinity to ambient bone tissues. However, a small amount of α-type tribasic calcium phosphate (α-TCP) may remain in the porous calcium phosphate body. While hydroxyapatite keeps its shape in a living body for a certain period of time, α-TCP is easily dissolved in a living body, inducing bone regeneration. Because too much α-TCP provides the porous calcium phosphate body with too small strength, and because α-TCP is rapidly dissolved in a living body, the amount of the remaining α-TCP is preferably as small as possible. For example, in an X-ray diffraction pattern, a main peak of α-TCP is preferably 0.5-5%, more preferably 0.5-3% of the main peak of hydroxyapatite.

The present invention will be explained in further detail by Examples below without intention of restricting the present invention thereto.

### Example 1

6.0 g of calcium phosphate powder comprising 74.9% by mass of tribasic calcium phosphate, 5% by mass of dibasic calcium phosphate, 18% by mass of tetrabasic calcium phosphate, 0.1% by mass of magnesium phosphate, and 2% by mass of hydroxyapatite was mixed with 1.0 g of sodium hydrogen carbonate powder and 1.0 g of citric acid powder, to produce a powdery agent. Also, 1.7 ml of an aqueous blending liquid containing sodium chondroitin sulfate in a concentration of 7.0% by mass and disodium succinate anhydride in a concentration of 15.0% by mass was prepared.

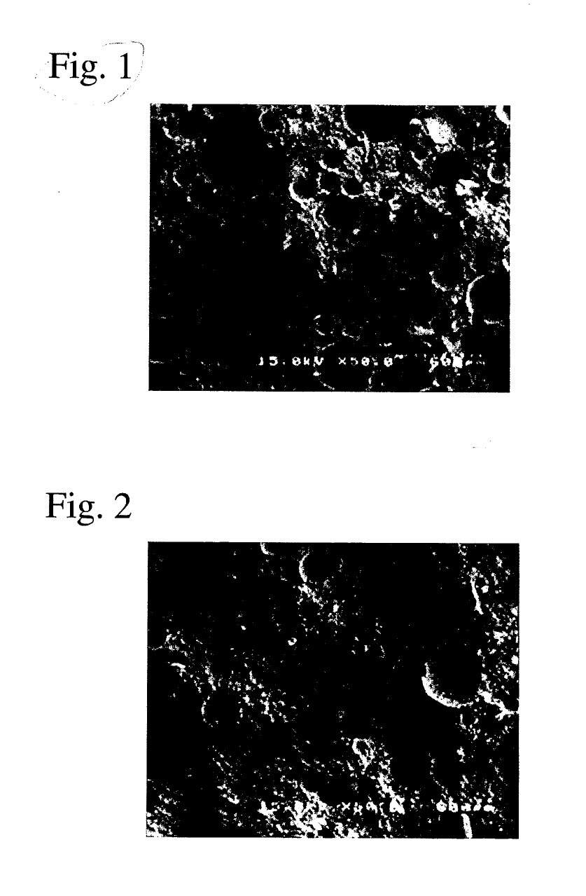

A paste-like mixture obtained by blending the above powdery agent and the above aqueous blending liquid was smoothly extruded from a syringe needle. The extruded paste-like mixture was foamed and hardened at room temperature, resulting in a porous calcium phosphate body after 10 minutes. As shown in FIG. 1, the porous calcium phosphate body had large numbers of communicating pores with porosity of 65%. The average pore size determined from the scanning electron photomicrograph of FIG. 1 was 230 μm.

### Example 2

A porous calcium phosphate body was formed in the same manner as in Example 1, except that each of sodium hydrogen carbonate and citric acid was 0.5 g in the powdery agent. As shown in FIG. 2, this porous calcium phosphate body had large numbers of communicating pores, with porosity of 60%. The average pore size determined from the scanning electron photomicrograph of FIG. 2 was 110 μm.

### Example 3

A porous calcium phosphate body was formed in the same manner as in Example 1, except that sodium chondroitin sulfate had a concentration of 10% by mass in the aqueous blending liquid. The paste-like mixture of the powdery agent and the aqueous blending liquid had extremely high viscosity and was hardened after 10 minutes, to form a porous calcium phosphate body free from cracks due to foaming. This porous calcium phosphate body had large numbers of communicating pores, with porosity of 70%.

### Comparative Example 1

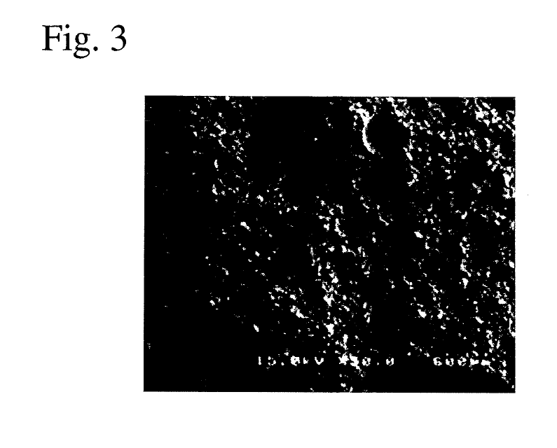

A porous calcium phosphate body was formed in the same manner as in Example 1 except for adding no powdery foaming agent. As shown in FIG. 3, most pores were not communicating with each other, and did not have sufficient diameters.

### EFFECT OF THE INVENTION

A high-viscosity paste-like mixture with good foam retention can be formed by blending the calcium phosphate cement composition of the present invention comprising calcium phosphate powder, a powdery foaming agent comprising carbonate or hydrogen carbonate and a solid organic acid or its salt, and a high-concentration thickener, with water, and can be fit into a prosthetic site of any shape. A porous calcium phosphate body obtained from the paste-like mixture has proper communicating pores, with high porosity. Further, because the thickener acts as a binder resin after the hardening of the calcium phosphate cement composition, the porous calcium phosphate body has sufficiently high strength (self-supportability). Because cells and bone morphogenetic proteins easily enter and are fixed in proper communicating pores of the porous calcium phosphate body, the porous calcium phosphate body has excellent bone absorption/substitution capability.

Using the calcium phosphate cement composition kit of the present invention, a paste-like mixture with desired fluidity can be obtained simply by blending the powdery agent and the aqueous blending liquid at an operation site, and the porous calcium phosphate body can be easily shaped such that it is fit into a prosthetic site having an arbitrary shape, with little burden on a human body during the prosthetic process. The calcium phosphate cement composition and its kit having such feature according to the present invention are suitable as bone prosthesis materials, for example, for curing bone defects or cavities, curing broken bones, assisting the fixing of broken bones, fixing metal screws for bonding bones, filling gaps between artificial joints and bones.

1. A calcium phosphate cement composition comprising (a) 100 parts by mass of calcium phosphate powder, (b) 10-50 parts by mass of a powdery foaming agent comprising carbonate or hydrogen carbonate and a solid organic acid or its salt, and (c) 15-50 parts by mass of an aqueous blending liquid, said aqueous blending liquid containing a thickener in a concentration of 2.5-12.5% by mass, a paste-like mixture obtained by their blending being filled in a predetermined prosthetic site in a human body to form a porous calcium phosphate body having porosity of 60% or more.

2. The calcium phosphate cement composition according to claim 1, which further comprises 2-10 parts by mass of a hardening accelerator per 100 parts by mass of said calcium phosphate powder.

3. The calcium phosphate cement composition according to claim 1, wherein said calcium phosphate powder comprises tribasic calcium phosphate as a main component.

4. The calcium phosphate cement composition according to claim 3, wherein said calcium phosphate powder comprises, in addition to said tribasic calcium phosphate, 2-10% by mass of dibasic calcium phosphate, 10-25% by mass of tetrabasic calcium phosphate, 5% or less by mass of other calcium phosphate compounds than said dibasic to tetrabasic calcium phosphates, and 0.03-2% by mass of magnesium phosphate.

5. The calcium phosphate cement composition according to claim 1, wherein said carbonate is at least one selected from the group consisting of sodium carbonate, potassium carbonate, magnesium carbonate, calcium carbonate and ammonium carbonate, said hydrogen carbonate is at least one selected from the group consisting of sodium hydrogen carbonate, potassium hydrogen carbonate, magnesium hydrogen carbonate, calcium hydrogen carbonate and ammonium hydrogen carbonate, and said solid organic acid is at least one selected from the group consisting of solid aliphatic carboxylic acids, solid aliphatic hydroxycarboxylic acids, ascorbic acid, aspartic acid and glutamic acid.

6. The calcium phosphate cement composition according to claim 1, wherein said carbonate or hydrogen carbonate is sodium hydrogen carbonate, and said solid organic acid is citric acid.

7. The calcium phosphate cement composition according to claim 1, wherein said thickener is at least one selected from the group consisting of sodium chondroitin sulfate, sodium hyaluronate and carboxymethylcellulose.

8. The calcium phosphate cement composition according to claim 2, wherein said hardening accelerator is at least one selected from the group consisting of sodium lactate, disodium succinate, sodium phosphate and sodium chloride.

9. A calcium phosphate cement composition kit comprising (A) a powdery agent comprising (a) 100 parts by mass of calcium phosphate powder, and (b) 10-50 parts by mass of a powdery foaming agent comprising carbonate or hydrogen carbonate and a solid organic acid or its salt, and (B) a aqueous blending liquid containing a thickener in a concentration of 2.5-12.5% by mass, a paste-like mixture obtained by blending said powdery agent with said aqueous blending liquid in such a proportion that said aqueous blending liquid is 15-50 parts by mass per 100 parts by mass of said calcium phosphate powder being filled in a predetermined prosthetic site in a human body to form a porous calcium phosphate body having porosity of 60% or more.

10. The calcium phosphate cement composition kit according to claim 9, wherein said aqueous blending liquid further comprises 2-10 parts by mass of a hardening accelerator, per 100 parts by mass of the calcium phosphate powder.

11. The calcium phosphate cement composition kit according to claim 9, wherein said calcium phosphate powder comprises tribasic calcium phosphate as a main component.

12. The calcium phosphate cement composition kit according to claim 11, wherein said calcium phosphate powder contains, in addition to said tribasic calcium phosphate, 2-10% by mass of dibasic calcium phosphate, 10-25% by mass of tetrabasic calcium phosphate, 5% or less by mass of other calcium phosphate compounds than said dibasic to tetrabasic calcium phosphates, and 0.03-2% by mass of magnesium phosphate.

13. The calcium phosphate cement composition kit according to claim 9, wherein said carbonate is at least one selected from the group consisting of sodium carbonate, potassium carbonate, magnesium carbonate, calcium carbonate and ammonium carbonate, said hydrogen carbonate is at least one selected from the group consisting of sodium hydrogen carbonate, potassium hydrogen carbonate, magnesium hydrogen carbonate, calcium hydrogen carbonate and ammonium hydrogen carbonate, and said solid organic acid is at least one selected from the group consisting of solid aliphatic carboxylic acids, solid aliphatic hydroxycarboxylic acids, ascorbic acid, aspartic acid and glutamic acid.

14. The calcium phosphate cement composition kit according to claim 9, wherein said carbonate or hydrogen carbonate is sodium hydrogen carbonate, and said solid organic acid is citric acid.

15. The calcium phosphate cement composition kit according to claim 9, wherein said thickener is at least one selected from the group consisting of sodium chondroitin sulfate, sodium hyaluronate and carboxymethylcellulose.

16. The calcium phosphate cement composition kit according to claim 9, wherein said hardening accelerator is at least one selected from the group consisting of sodium lactate, disodium succinate, sodium phosphate and sodium chloride.

17. The calcium phosphate cement composition according to claim 2, wherein said calcium phosphate powder comprises tribasic calcium phosphate as a main component.

18. The calcium phosphate cement composition according to claim 17, wherein said calcium phosphate powder comprises, in addition to said tribasic calcium phosphate, 2-10% by mass of dibasic calcium phosphate, 10-25% by mass of tetrabasic calcium phosphate, 5% or less by mass of other calcium phosphate compounds than said dibasic to tetrabasic calcium phosphates, and 0.03-2% by mass of magnesium phosphate.

19. The calcium phosphate cement composition kit according to claim 10, wherein said calcium phosphate powder comprises tribasic calcium phosphate as a main component.

20. The calcium phosphate cement composition kit according to claim 19, wherein said calcium phosphate powder contains, in addition to said tribasic calcium phosphate, 2-10% by mass of dibasic calcium phosphate, 10-25% by mass of tetrabasic calcium phosphate, 5% or less by mass of other calcium phosphate compounds than said dibasic to tetrabasic calcium phosphates, and 0.03-2% by mass of magnesium phosphate.
